(19) United States
(12) Patent Application Publication
(10) Pub. No.: US 2024/0084215 A1
(43) Pub. Date: Mar. 14, 2024

(54) Human Molecular Extraction HME

(71) Applicant: Leslie Yellin, Warwick, NY (US)

(72) Inventor: Leslie Yellin, Warwick, NY (US)

(21) Appl. No.: 17/851,071

(22) Filed: Jun. 28, 2022

(51) Int. Cl. C11B 9/00

(52) U.S. Cl. CPC C11B 9/0003

(57) ABSTRACT

The present invention relates to a novel method of human scent extraction from a person's body or used articles and storing it in a preserved manner which can be used in various forms. The proposed method is mainly directed toward pets training, development of comfort and elimination of anxiety and can also trigger connections in the dog or cats brain.

### BACKGROUND

### Field of the Invention

This invention is generally related to the fields of pet care. More specifically, the invention concerns novel fragrance compositions and products containing such fragrance compositions. This invention also pertains to the scent molecules of humans, and to the incorporation of personalized fragrance compositions for better mental and physical connection with pets.

### Description of the Related Art

The aroma components from natural products have been used for mental, spiritual and physical healing since the beginning of recorded history. In aromatherapy, fragrance substances (aroma/odor/scent) from various natural sources have been used for the treatment of various disorders. The aromatherapy treatment is a natural way of healing a person's mind, body and soul. Many ancient civilizations, including Egypt, China and India, have used aromatherapy as a popular complementary and alternative therapy for more than thousands of years. In traditional medicine as well as in aromatherapy and herbal medicine, essential oils and fragrance compounds have been used for the treatments of various psychological and physical disorders such as headaches, pain, insomnia, eczema, stress-induced anxiety, depression and digestive problems. In recent years, various studies have revealed that olfactory stimulation through fragrance inhalation exerts various psychophysiological effects on human beings. There are various methods available to administer the fragrances in small quantities, including inhalation, massage or simple applications on the skin surface and, sometimes, they can be taken internally.

In our daily life, several fragrances appear, and a sense of smell plays an important role in the physiological effects of mood, stress, and working capacity. Fragrance is a volatile chemical component with a molecular weight of <300 Da that humans perceive via the olfactory system. In the olfactory process, the fragrant molecules in the air attach to the cilia of olfactory receptors in the olfactory epithelium, located in the nasal cavity. Then the guanine nucleotide binding protein (G-protein) coupled receptors (GPCR) are activated and electrical signals are generated. Subsequently, the electrical signals are transmitted to the brain by olfactory sensory neurons via olfactory bulb and higher olfactory cortex. Consequently, these electrical signals modulate the brain functions including memory, thoughts, and emotions. Many studies describe that the inhalation of fragrances highly affect the brain function since the fragrance compounds are able to cross the blood-brain barrier and interact with receptors in the central nervous system. Furthermore, many studies have suggested that the olfactory stimulation of fragrances produces immediate changes in physiological parameters such as blood pressure, muscle tension, pupil dilation, skin temperature, pulse rate and brain activity. Hence, the studies in relation to the role of fragrances in the brain functions of healthy and diseased subjects have significantly increased in the past decades.

There are numerous techniques that have been developed to examine the brain function. The emotional and behavior alterations by fragrance inhalation have been assessed by different electrophysiological methods such as electroencephalograph (EEG), contingent negative variation, near infrared spectroscopy, and functional magnetic resonance imaging.

There are multiple solutions that have been presented in prior art in regarding development of effective odor components. However, the personalization component of odors/fragrances still needs advancement.

The present invention overcomes the disadvantages of the prior art. It has to be noted that the current invention proposes an advancement where it provides a new approach of providing a personalized odor development by rubbing sterile cotton pads on any part of skin/hair/body. The goal particularly aims in providing a fragrance which contains a personalized scent of human body and can be used to comfort the pets or trigger a positive feeling. The approach provides a novel method of blending the Human Scent Molecules that are designed to help eliminate anxiety in pets.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve upon prior pet care approaches and provide an enhanced procedure to perform the designated functionality.

Another object of the present invention is to provide an efficient and safe apparatus aimed at creating a scent from human's body odor and use it for various purposes.

It is a further objective of the present invention to provide a method which helps in reducing or eliminating the anxiety in pets.

It is also the objective of the invention to provide an method which uses the human scent molecules for dogs in training for locating or tracking people.

It is further the objective of invention to provide extracted scent molecules are used to be inhaled and trigger connections in the dog or cats brain to a person.

It is also the objective of the invention to provide a whole construction which is compatible with high volume manufacturing methods for all of the components. The low manufacturing cost means that this high-quality technique may be made available to people that may otherwise not be able to afford a quality approaches.

Thus, it is the objective to provide a new and improved form of an advancement in a Human Molecular Extraction technique, Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The fragrances are mainly volatile organic compounds with characteristic, usually pleasant odors. They have been used for thousands of years to deliver a variety of benefits, especially for the physical and psychological well-being of humans. Smells are handled by the olfactory bulb, the structure in the front of the brain that sends information to the other areas of the body's central command for further processing. Odors take a direct route to the limbic system, including the amygdala and the hippocampus, the regions related to emotion and memory. The olfactory signals are considered to reach very quickly get to the limbic system.

The present invention aims to develop a personalized scent which is developed from a human body and can be used for various purposes. Human body odor can be extracted by using including but not limited to tissues, cotton wool and other similar materials. These scent molecules can also be collected from fabric, leather, plastic, glass, wood, paper.

The preserved scent on cotton pads that have been rubbed on body can be placed into a sterile glass jar and pour in a solution to extract the scent molecules from the cotton material. The scent molecules that are extracted are now in the liquid solution. These scent molecules can be used to develop various types of cosmetic preparations where the end user of these products will be pets. This will help the pets to develop the comfort and lower their anxiety even when the owner isn't around. The human scent molecules for dogs also assist in training for locating or tracking people. The extracted scent molecules are used to be inhaled and trigger connections in the dog or cats' brain to a person.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method of extraction of human scent molecules to be used in various products wherein:
As per claim 1, the method used is universal in nature;
As per claim 1, the method allows collection of scent molecules;
As per claim 1, the collection of scent molecules can be done by rubbing sterile cotton pads on any part of human skin/hair/body; and,
As per claim 1, the collection of scent molecules can be collected from multiple articles including but not limited to fabric, leather, plastic, glass, wood, paper;

2. A process of extraction of human scent wherein the process involves placing them into a sterile glass jar and pour in a solution to extract the scent molecules from the cotton material. The scent molecules that are extracted are in the liquid solution and can be used in variety of presentations.
